(19) United States
(12) Patent Application Publication
(10) Pub. No.: US 2022/0335323 A1
(43) Pub. Date: Oct. 20, 2022

(54) SOLUTION SYSTEM, SOLUTION METHOD, AND SOLUTION PROGRAM

(71) Applicant: NEC Corporation, Minato-ku, Tokyo (JP)

(72) Inventors: Fumiyo TAKANO, Tokyo (JP); Hiroshi CHISHIMA, Tokyo (JP)

(73) Assignee: NEC Corporation, Minato-ku, Tokyo (JP)

(21) Appl. No.: 17/642,332

(22) PCT Filed: Sep. 24, 2019
(86) PCT No.: PCT/JP2019/037332

§ 371 Date: Mar. 11, 2022

(51) Int. Cl. G06N 10/60

(52) U.S. Cl. CPC G06N 10/60

(57) ABSTRACT

Provided is a solution system capable of reducing the amount of computation when solving a combinatorial optimization problem by applying an energy function in a model representing a state of individual spins by a first value or a second value to simulated annealing. The input unit 2 receives input of an energy function in a model representing states of individual spins by a first value or a second value, wherein the energy function is corresponding to a combinatorial optimization problem to be solved. In a process of the simulated annealing, the simulated annealing unit 3 selects a spin, selects a set to which the spin belongs, and changes the states of one or more spins including the spin while a condition where the set satisfies a constraint is maintained, when the set satisfies the predetermined constraint and the state of the spin is determined to be changed.

### TECHNICAL FIELD

The present invention relates to a solution system, a solution method and a solution program, and in particular to a solution system, a solution method and a solution program for obtaining a state of each spin corresponding to a solution of a combinatorial optimization problem (a state of each spin of a predetermined model).

### BACKGROUND ART

Research on quantum computers for solving combinatorial optimization problems is in progress. A quantum computer solves a combinatorial optimization problem using an energy function in the Ising model as an input. Examples of combinatorial optimization problems are the traveling salesman problem, the knapsack problem, and the graph partitioning problem. However, the combinatorial optimization problem is not limited to these problems.

The Ising model is a model in statistical mechanics that represents the behavior of a magnetic material by individual spins, and it is also applicable to solving combinatorial optimization problems. In the Ising model, the states of individual spins are represented by “1” or “−1”.

In addition, QUBO (Quadratic Unconstrained Binary Optimization) is also known as a model in which the states of individual spins are represented by “1” or “0”.

Note that “1” in the Ising model and “1” in QUBO can be referred to as the first value, and, “−1” in the Ising model and “0” in QUBO can be referred to as the second value.

The energy function in the Ising model and the energy function in QUBO are mutually convertible.

At present, quantum computers of sufficient scale to solve combinatorial optimization problems in the real world have not been realized.

In order to obtain the solution of various combinatorial optimization problems in a generic way, the solution of the combinatorial optimization problem is obtained by simulated annealing using a general computer with the energy function in the Ising model or in QUBO as input. An example of this method is described below. Here, the case of finding a solution to the traveling salesman problem is took as an example.

First, an expression that represents the energy in the traveling salesman problem is generated. The generation of the expression representing the energy in the combinatorial optimization problem may be referred to as formulation. An example of the expression obtained by the formulation of the traveling salesman problem is Expression (1) shown below.

$$\begin{matrix}[ Math . 1 ] & \\ H = α {\sum }_{v = 1}^{n} {( 1 - {\sum }_{j = 1}^{N} {x}_{v , j} )}^{2} + α {\sum }_{j = 1}^{n} {( 1 - {\sum }_{v = 1}^{N} {x}_{v , j} )}^{2} + β {\sum }_{( uv ) ∈ E} {W}_{uv} {\sum }_{j = 1}^{N} {x}_{u , j} {x}_{v , j + 1} & ( 1 )\end{matrix}$$

In Expression (1), j represents a time, and v and u represent cities. Also, x_{v,j} is a variable that represents whether or not the salesman is in city v at the time j, and corresponds to the spin. x_{v,j}=1 means that the salesman is in the city v at the time j, and x_{v,j}=0 means that the salesman is not in the city v at the time j. FIG. 10 is a schematic diagram showing an example of the representation of the state of each spin in the traveling salesman problem. In Expression (1), Wᵤᵥ is a distance between cities u and v, which is predetermined as a constant for each pair of cities. α and β are predetermined as constants.

The first term on the right-hand side in Expression (1) represents a constraint that the salesman can never pass through the same city two times or more.

The second term on the right-hand side in Expression (1) represents a constraint that the salesman is only present in one city at one time.

The third term on the right-hand side in Expression (1) represents a distance between the cities through which the salesman passes.

Once the expression representing the energy in the combinatorial optimization problem as exemplified in Expression (1) has been generated, the expression is converted to the energy function in the Ising model or the energy function in QUBO. This conversion method is known.

The energy function in the Ising model is expressed as the following Expression (2).

[Math. 2]

H_{Ising}=ΣᵢⱼJᵢⱼsᵢsⱼ+Σᵢhᵢsᵢ (2)

In Expression (2), sᵢ, sⱼ are variables that represent a state of a spin. Jᵢⱼ is a constant related to i and j, and hᵢ is a constant related to i.

The energy function in QUBO is expressed as the following Expression (3).

[Math. 3]

H_{QUBO}=ΣᵢⱼQᵢⱼxᵢxⱼ (3)

In Expression (3), xᵢ, xⱼ are variables that represent a state of a spin. Qᵢⱼ is a constant related to i and j.

Expression (2) and Expression (3) are second-order expressions of the variables that represent the states of spins. Expression (1) is also a second-order expression of the variables that represent the states of spins. Therefore, Expression (1) can be converted to Expression (2) or Expression (3).

Even if the order of the variables representing the states of spins in the expression obtained by the formulation is the third order or higher, the order of the variables representing the states of spins can be reduced to the second order, by replacing a plurality of the variables representing the states of spins with a single variable. Therefore, even if the order of the variables representing the states of spins in the expression obtained by the formulation is the third order or higher, the energy function in the Ising model (Expression (2)) or the energy function in QUBO (Expression (3)) can be obtained based on the expression. In the case where a plurality of variables representing the states of spins are replaced by a single variable, the spin represented by the replaced variable is called the auxiliary spin.

Once the energy function in the Ising model or QUBO is obtained, the energy function is applied to simulated annealing to identify the state of each spin when the energy is minimized. Then, the optimal solution is obtained by interpreting the state of each spin according to the combinatorial optimization problem (in this example, the traveling salesman problem).

With this method, solutions to various combinatorial optimization problems can be obtained in a generic manner.

PLT 1 also describes changing a plurality of spin values simultaneously.

### CITATION LIST

### Patent Literature

PTL 1: Japanese Patent Application Laid-Open No. 2018-206127

### SUMMARY OF INVENTION

### Technical Problem

As described above, by applying the energy functions in the Ising model or QUBO to simulated annealing, solutions to various combinatorial optimization problems can be obtained in a generic manner.

However, in this case, the number of search candidates in the problem space becomes extremely large compared to the number of search candidates in the problem space in the solution methods specialized for individual combinatorial optimization problems.

The number of search candidates are compared using the traveling salesman problem with four cities as an example. The four cities are denoted by signs A, B, C and D. FIG. 11 is a schematic diagram showing the search candidates in the solution method specialized for the traveling salesman problem. As can be seen from FIG. 11, the number of search candidates in this example is 6.

FIG. 12 is a schematic diagram showing the search candidates in the method of applying the energy function in QUBO to simulated annealing. When there are four cities, the number of spins is 4²=16. Each spin takes the value of either 1 or 0. Therefore, the number of search candidates in this example is 2¹⁶. In the case of the Ising model, each spin takes the value of either 1 or −1, and the number of search candidates is 2¹⁶ as in the case of QUBO.

Thus, in the method of applying the energy function to simulated annealing, the number of search candidates becomes extremely large compared to the number of search candidates in the solution method specialized for an individual combinatorial optimization problem. Moreover, this tendency becomes more pronounced if the combinatorial optimization problem becomes more complex, as in the case of increasing the number of cities in the traveling salesman problem.

The method of applying the energy function to simulated annealing requires a large amount of computation because of the extremely large number of search candidates. As a result, the time to obtain a solution is also longer.

Therefore, an object of the present invention is to provide a solution system, a solution method, and a solution program that can reduce the amount of computation when solving a combinatorial optimization problem by applying an energy function in a model representing a state of individual spins by a first value or a second value to simulated annealing.

### Solution to Problem

A solution system according to the present invention comprises: an input unit that receives input of an energy function in a model representing states of individual spins by a first value or a second value, wherein the energy function is corresponding to a combinatorial optimization problem to be solved; and a simulated annealing unit that obtains a state of each spin corresponding to a solution of the combinatorial optimization problem by performing simulated annealing when the energy function is input, wherein, in a process of the simulated annealing, the simulated annealing unit selects a spin, selects a set to which the spin belongs, and changes the states of one or more spins including the spin while a condition where the set satisfies a constraint is maintained, when the set satisfies the predetermined constraint and the state of the spin is determined to be changed.

A solution method according to the present invention comprises: receiving input of an energy function in a model representing states of individual spins by a first value or a second value, wherein the energy function is corresponding to a combinatorial optimization problem to be solved; and obtaining a state of each spin corresponding to a solution of the combinatorial optimization problem by performing simulated annealing when the energy function is input, a process of the simulated annealing comprising: selecting a spin, selecting a set to which the spin belongs, and changing the states of one or more spins including the spin while a condition where the set satisfies a constraint is maintained, when the set satisfies the predetermined constraint and the state of the spin is determined to be changed.

A solution program according to the present invention is to be installed in a computer that comprises an input unit that receives input of an energy function in a model representing states of individual spins by a first value or a second value, wherein the energy function is corresponding to a combinatorial optimization problem to be solved, the solution program causing the computer to perform: a simulated annealing processing of obtaining a state of each spin corresponding to a solution of the combinatorial optimization problem by performing simulated annealing when the energy function is input, wherein the solution program causes the computer to perform, in a process of the simulated annealing, selecting a spin, selecting a set to which the spin belongs, and changing the states of one or more spins including the spin while a condition where the set satisfies a constraint is maintained, when the set satisfies the predetermined constraint and the state of the spin is determined to be changed.

### Advantageous Effects of Invention

According to the present invention, the amount of computation when solving a combinatorial optimization problem by applying an energy function in a model representing a state of individual spins by a first value or a second value to simulated annealing can be reduced.

### BRIEF DESCRIPTION OF DRAWINGS

FIG. 1 It depict a block diagram showing a configuration example of a solution system of an example embodiment of the present invention.

FIG. 2 It depict a schematic diagram of an example of a set containing a plurality of basic spins and one auxiliary spin.

FIG. 3 It depicts a schematic diagram showing an example of the state of each spin in the concrete example 1.

FIG. 4 It depicts a schematic diagram showing the results of flipping the spins 61, 62 shown in FIG. 3.

FIG. 5 It depicts a schematic diagram showing an example of a two-dimensional matrix representing the state of each basic spin and a two-dimensional matrix representing the state of each auxiliary spin in the concrete example 2.

FIG. 6 It depicts a flowchart showing an example of a processing progress of the solution system of the example embodiment of the present invention.

FIG. 7 It depicts a flowchart showing an example of a processing progress of the solution system of the example embodiment of the present invention.

FIG. 8 It depicts a schematic block diagram showing an example of a computer configuration of the solution system of the example embodiment of the present invention.

FIG. 9 It depicts a block diagram showing an overview of the solution system of the present invention.

FIG. 10 It depicts a schematic diagram showing an example of the representation of the state of each spin in the traveling salesman problem.

FIG. 11 It depicts a schematic diagram showing the search candidates in the solution method specialized for the traveling salesman problem.

FIG. 12 It depicts a schematic diagram showing the search candidates in the method of applying the energy function in QUBO to simulated annealing.

### DESCRIPTION OF EMBODIMENTS

An example embodiment of the present invention is described below with reference to the drawings.

As mentioned earlier, “1” in the Ising model and “1” in QUBO can be referred to as the first value, and, “−1” in the Ising model and “0” in QUBO can be referred to as the second value. The Ising model and QUBO are both models in which the state of each spin is represented by the first value or the second value.

In the example embodiment, the case in which the energy function in QUBO is input to the solution system of the present invention is described as an example, but the case in which the energy function in the Ising model is input can be described in the same way. Instead of the energy function in QUBO, the energy function in the Ising model may be input to the solution system of the present invention.

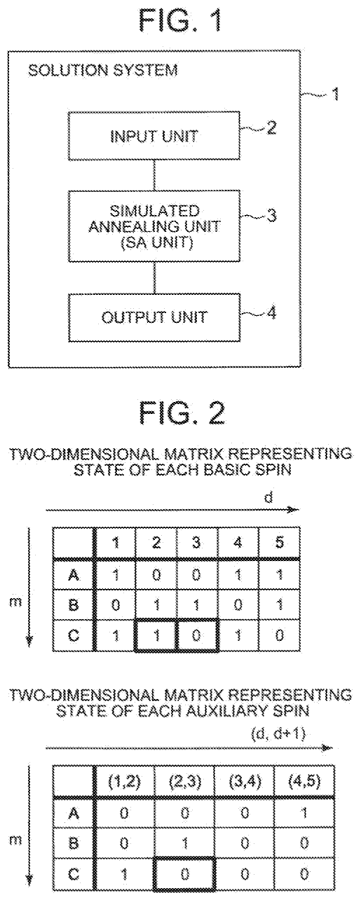

FIG. 1 is a block diagram showing a configuration example of a solution system of the example embodiment of the present invention. The solution system 1 of this example embodiment includes an input unit 2, a simulated annealing unit 3, and an output unit 4. The simulated annealing unit 3 is hereinafter referred to as the SA unit 3.

The input unit 2 receives input of an energy function in QUBO, which is an energy function corresponding to a combinatorial optimization problem to be solved. This energy function is obtained by converting the expression representing the energy in the combinatorial optimization problem.

The input unit 2 is, for example, an input device to which the energy function is input. The input unit 2 may be an input device such as a data reading device that reads an energy function recorded on a recording medium.

From the energy function input to the input unit 2, the representation format of the state of each spin is determined. In the following, for the sake of simplicity, the case in which the state of each spin is represented by a two-dimensional matrix is used as an example. However, the representation format of the state of each spin is not necessarily the two-dimensional matrix, and depending on the combinatorial optimization problem, the representation format of the state of each spin may be a three-dimensional matrix or a format in which the state of each spin is represented individually.

In this example embodiment, the sets of spins and the constraint to be satisfied by each set are predetermined. A plurality of sets of spins are defined, and constraint are defined for each set.

Each set of spins and the constraint defined for each set may be defined, for example, by a user of the solution system 1. Each set and the constraint for each set defined by the user may be input, for example, via the input unit 2. However, the manner in which each set and the constraint for each set are set is not limited to the above examples. For example, each set and the constraint for each set may be described in the solution program for realizing the operation of the present example embodiment.

A single spin may belong to multiple sets.

Various examples of constraint that can be set for a set of spins are described below.

(1) An example of the constraint on a set of spins is the constraint that only one spin among a plurality of spins belonging to the set is set to “1” and all other spins in the set are set to “0”. This constraint is hereinafter referred to as the “first constraint”.

(2) Another example of the constraint on a set of spins is the constraint that at least one spin among a plurality of spins belonging to the set is set to “0”. This constraint is hereinafter referred to as the “second constraint”.

(3) Another example of the constraint on a set of spins is the constraint that at least one spin among a plurality of spins belonging to the set is set to “1”. This constraint is hereinafter referred to as the “third constraint”.

(4) Another example of a constraint on a set of spins is described below. The constraint described below will be referred to as the “fourth constraint”. The fourth constraint is applied, in the case that, since the order of the variable representing the states of spins in the expression representing the energy in the combinatorial optimization problem (expression obtained by formulation) is third order or higher, the order of the variable representing the states of spins is reduced to second order by replacing a plurality of variables representing the states of spins with a single variable, and further, the expression representing the energy whose order of the variables representing the states of spins is reduced to the second order is converted into an energy function.

In this case, the state of the spin represented by the variable before the replacement and the state of the spin (the auxiliary spin) represented by the variable after the replacement are expressed separately. The spin represented by the variable before replacement may be referred to as the basic spin. The sets of spins are defined so that the plurality of basic spins corresponding to the plurality of variables before the replacement and the auxiliary spin corresponding to the variable after the replacement form a set. The fourth constraint is that if the state of the basic spins belonging to a set is changed, the state of the auxiliary spins is changed according to the result of the change.

The fourth constraint is presented in more detail below. Suppose that the state of each basic spin is represented by a two-dimensional matrix. Suppose that the rows of this two-dimensional matrix are represented by the variable m, the columns are represented by the variable d, and the variable representing the state of the basic spin according to the row and column is x_{m,d}. Then, suppose that the plurality of variables x_{m,d}, x_{m,d+1} representing the states of the basic spins are converted into one variable y_{m,(d, d+1)} representing the state of the auxiliary spin by the following Expression (4).

y_{m,(d,d+1)}=x_{m,d}×x_{m,d+1} (4)

FIG. 2 is a schematic diagram of an example of a set containing a plurality of basic spins and one auxiliary spin, in this example. As shown in FIG. 2, the two-dimensional matrix showing the state of each basic spin and the two-dimensional matrix showing the state of each auxiliary spin are separate matrices. In FIG. 2, it is shown that the basic spin x_{C,2}, the basic spin x_{C,3}, and the auxiliary spin y_{C,(2, 3)} are in one set. However, the sets in this example are not limited to this one, but there are many. In addition, for each of those sets, the fourth constraint is assumed to be defined.

In the example shown in FIG. 2, x_{C,2}=1, x_{C,3}=0, and y_{C,(2, 3)}=0. When the basic spin x_{C,3} is changed from “0” to “1”, y_{C,(2, 3)} is also changed from “0” to “1” based on the fourth constraint.

In this example, the basic spin x_{C,3}, the basic spin x_{C,4}, and the auxiliary spin y_{C,(3, 4)} are also one set, so in the above example, the auxiliary spin y_{C,(3, 4)} is also changed from “0” to “1”.

Each of the above constraints, from the first constraint to the fourth constraint, is a constraint on a set of spins. In this example embodiment, not only constraints on sets of spins, but also constraints on spins may be defined. Examples of constraints on spins are described below.

As an example of a constraint on spins, the constraint is that a predetermined spin takes only one of two values: the first value (“1” in QUBO”) and the second value (“0” in QUBO), and that the value of the predetermined spin does not change. In other words, this constraint is a constraint that the first value or the second value is defined as a fixed value for a predetermined spin. This constraint is hereinafter referred to as the “fifth constraint”. The spin for which the fifth constraint is set and the fixed value taken by the spin are predetermined. The spin for which the fifth constraint is set and the fixed value taken by the spin may be determined, for example, by the user and input via the input unit 2. The manner of setting the spin for which the fifth constraint is set and the fixed value taken by the spin is not limited to the above examples. For example, the spin for which the fifth constraint is set and the fixed value taken by the spin may be described in the solution program.

The number of spins for which the fifth constraint is set may be one or two or more. However, the fifth constraint is not set for all the spins. The spins for which the fifth constraint is set are hereinafter referred to as fixed spins.

Among the first constraint to the fifth constraint, one type of constraint may be set, or multiple types of constraints may be set. Also, constraints other than the first constraint to the fifth constraint may be set.

The SA unit 3 (the simulated annealing unit 3) obtains the state of each spin corresponding to the solution of the combinatorial optimization problem by performing simulated annealing when the energy function is input. The SA unit 3 will be described in more detail.

When the energy function is input, the SA unit 3 randomly determines the values of individual spins under the representation format of the states of spins. As described above, for simplicity of explanation, the case where the representation format of the states of spins is a two-dimensional matrix is taken as an example. In this case, the SA unit 3 randomly determines the values of the individual spins in the two-dimensional matrix. If there are auxiliary spins, the values of the individual auxiliary spins are also randomly determined. However, for fixed spins (spins for which the fifth constraint has been set), the SA unit 3 sets the fixed value for the fixed spin (“1” or “0”) determined for the fixed spin. At this point, it is not necessarily the case that the constraints defined for each set are satisfied.

When performing simulated annealing, the SA unit 3 first selects one spin and then selects one set to which the spin belongs.

If the SA unit 3 determines that the selected set satisfies the constraint defined for the set and that the state of the selected spin is to be changed, the SA unit 3 changes the state of one or more spins including the selected spin while a condition where the set satisfies the constraint is maintained. In this case, it is possible that only the state of the selected spin is changed.

If the selected set does not satisfy the constraint defined for the set, the SA unit 3 determines whether or not to change the state of the selected spin. If it is determined that the state of the selected spin is to be changed, the SA unit 3 changes the state of the selected spin. At the time when the value of each spin is first randomly determined as described above, it is not necessarily the case that the constraints defined for each set are satisfied. However, as this operation is carried out, the number of sets that satisfy the constraint increases.

The SA unit 3 repeats the operation after the operation of selecting one spin. Then, for example, when the decision not to change the state of a spin occurs for a predetermined number of times in succession, the SA unit 3 determines that the state of each spin at that time is the state corresponding to the solution of the combinatorial optimization problem.

The SA unit 3 determines whether or not to change the spin state based on the transition probability in simulated annealing.

In addition, changing the state of spin may be described as “flipping spin”.

The output unit 4 outputs the state of each spin corresponding to the solution of the combinatorial optimization problem determined by the SA unit 3. For example, the output unit 4 may display the state of each spin corresponding to the solution of the combinatorial optimization problem on a display device (omitted in the figure) provided by the solution system 1. However, the output manner of the state of each spin corresponding to the solution of the combinatorial optimization problem is not particularly limited.

The SA unit 3 and the output unit 4 are realized, for example, by a CPU (Central Processing Unit) of a computer that operates according to a solution program. In this case, the CPU reads the solution program from a program recording medium such as a program storage device of the computer, and operates the SA unit 3 and the output unit 4 according to the solution program.

Next, concrete example where the SA unit 3 flips the spin with the constraints defined.

### Concrete Example 1

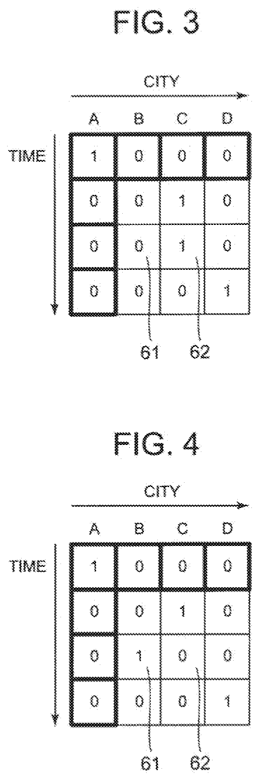

In the concrete example 1, the case where the first constraint and the fifth constraint are defined is used as an example. In addition, in the concrete example 1, the traveling salesman problem when the number of cities is four is used as an example. FIG. 3 is a schematic diagram showing an example of the state of each spin in the concrete example 1. In the concrete example 1, the state of each spin is represented by a two-dimensional matrix of four rows and four columns with the city and time as axes.

In this example, it is assumed that the four spins aligned in the horizontal direction are defined as one set in the matrix shown in FIG. 3. As shown in FIG. 3, since there are four rows of spins, four sets are defined. In each of the four sets, the first constraint is defined. This means that at any one time, a salesman can be in only one city.

In the example shown in FIG. 3, each of the four sets has already satisfied the first constraint.

The spins shown in bold frames in FIG. 3 are assumed to have fixed values (the fifth constraint). The value of the spin in the first row and the first column is set to “1”. Among the spins of the first row and the first column, the values of the spins other than the spin of the first row and the first column are set to “0” (see FIG. 3). The values of the fixed spins determined as shown in FIG. 3 mean that the salesman is in city A at the first time.

Suppose that the SA unit 3 selects the spin 61 when the state of each spin is the state shown in FIG. 3. In this case, the SA unit 3 selects one set to which the spin 61 belongs. In this example, the SA unit 3 selects a set consisting of four spins in the third row shown in FIG. 3. This set already satisfies the first constraint. Since it is not possible to maintain the condition that the first constraint is satisfied just by flipping spin 61, the SA unit 3 select other spins, other than fixed spins, to flip together with spin 61 while the condition that the first constraint is satisfied is maintained. Here, the SA unit 3 selects the spin 62 whose value is “1”.

Then, based on the transition probabilities in the simulated annealing, the SA unit 3 determines whether to flip the spins 61, 62 or not. If it is determined that spins 61 and 62 are to be flipped, the SA unit 3 flips spins 61, 62. This state is shown in FIG. 4. Even after the flip, the set corresponding to the third row satisfies the first constraint.

In the concrete example 1, a case in which four spins aligned in the horizontal direction are defined as one set is shown. The four spins aligned in the vertical direction may be defined as one set. In this case, there are also four sets. Suppose that the first constraint is set for each of those four sets (four columns) This means that the salesman will never pass through the same city more than once.

### Concrete Example 2

In the concrete example 2, the case where the second constraint, the third constraint, and the fourth constraint are defined is used as an example. In addition, in the concrete example 2, the combinatorial optimization problem of creating an optimal work shift table for five days is used as an example. Let the date be represented by the variable d, and let the personnel be represented by the variable m. It is also assumed that there are three personnel, A, B, and C.

Let the variable x_{m,d} denote whether or not personnel m works on date d. x_{m,d}=1 means that personnel m works on date d. x_{m,d}=0 means that personnel m does not work on date d. x_{m,d} corresponds to spin.

Furthermore, suppose that in this combinatorial optimization problem, there exists the constraint that working for three consecutive days is prohibited and the constraint that three consecutive days off is prohibited.

In this combinatorial optimization problem, the expression representing the energy is represented by Expression (5) shown below.

$$\begin{matrix}[ Math . 4 ] & \\ H = {\sum }_{m} {\sum }_{d} ( {x}_{m , d} {x}_{m , d + 1} {x}_{m , d + 2} ) + {\sum }_{m} {\sum }_{d} ( 1 - {x}_{m , d} ) ( 1 - {x}_{m , d + 1} ) ( 1 - {x}_{m , d + 2} ) + {\sum }_{d} ( {\sum }_{m} {x}_{m , d} - {w}_{d} ) & ( 5 )\end{matrix}$$

The first term on the right-hand side of Expression (5) represents the constraint that “working for three consecutive days is prohibited”.

The second term on the right-hand side of Expression (5) represents the constraint that “three consecutive days off is prohibited”.

The third term on the right-hand side of Expression (5) represents the difference between the number of working personnel and the required number of personnel for each day. w_{d} is the required number of personnel on date d and is determined as a constant according to d. In the combinatorial optimization problem in this example, it is desirable that the difference between the number of working personnel and the required number of personnel is small.

In Expression (5), the order of the variables representing the states of spins is third order. Therefore, it is assumed that a plurality of variables x_{m,d}, x_{m,d+1} representing the states of basic spins is replaced by one variable y_{m,(d, d+1)}. Expression (6) is the same as Expression (4) described above.

y_{m,(d,d+1)}=x_{m,d}×x_{m,d+1} (6)

By such replacement, the order of the variable representing the states of spins can be reduced to the second order. For example, x_{m,d}x_{m,d+1}x_{m,d+2} in the first term of the right-hand side of Expression (5) can be converted to a second-order expression such as Expression (7) shown below.

y_{m,d}x_{m,d+2}+x_{m,d}x_{m,d+1}−2x_{m,d}y_{m,d}−2x_{m,d+1}y_{m,d}+3y_{m,d} (7)

Similarly, the second term on the right-hand side of Expression (5) can also be converted to second order. The third term on the right-hand side of Expression (5) is, originally, second order.

The expression representing the energy with the order of the variables representing the states of spins reduced to the second order can be converted to the energy function in QUBO.

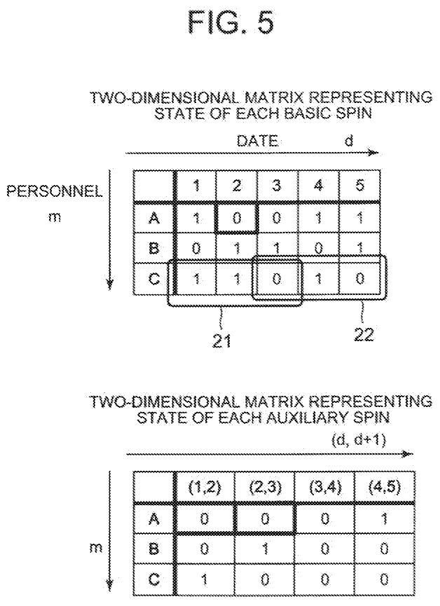

FIG. 5 is a schematic diagram showing an example of a two-dimensional matrix representing the state of each basic spin and a two-dimensional matrix representing the state of each auxiliary spin in the concrete example 2. In the initial state, the values of each basic spin and each auxiliary spin are randomly set to 1 or 0.

In this example, it is assumed that each set of basic spins is defined so that three basic spins aligned in the horizontal direction form one set. For example, x_{A,1}, x_{A,2}, and x_{A,3} are defined as one set, and x_{A,2}, x_{A,3}, and x_{A,4} are defined as one set. Similarly, other sets are defined. A single basic spin may belong to multiple sets. It is assumed that the second constraint and the third constraint are defined for each set of basic spins defined as above.

In addition, since the auxiliary spin is defined by Expression (6), for example, the set of the basic spin x_{A,1}, the basic spin x_{A,2}, and the auxiliary spin y_{A,(1, 2)} are defined. Similarly, the set of the basic spin x_{A,2}, the basic spin x_{A,3}, and the auxiliary spin y_{A,(2, 3)} are defined. In this way, a plurality of sets including the auxiliary spin are also defined. Then, the fourth constraint is defined for each set including the auxiliary spin.

In the concrete example 2, the case where the spin is flipped while the condition that the second constraint is satisfied is maintained is described. Suppose that the states of spins are the states shown in FIG. 5, and that the SA unit 3 selects spin x_{C,3}. In this case, the SA unit 3 selects one set to which the spin x_{C,3} belongs (a set consisting of only basic spins). In this example, it is assumed that the SA unit 3 selects the set 21 (see FIG. 5). The set 21 satisfies the second constraint. If only spin x_{C,3} is flipped, the values of all three spins belonging to the set 21 become “1” and the second constraint is no longer satisfied. Therefore, the SA unit 3 selects other spins to be flipped together with spin x_{C,3} from among the set 21. In this example, either one of spin x_{C,1} or spin x_{C,2} can be arbitrarily selected. Here, the case where spin x_{C,1} is selected will be described as an example.

The SA unit 3 determines whether or not to flip spin x_{C,3} and spin x_{C,1} based on the transition probabilities in the simulated annealing. If it is determined to flip spin x_{C,3} and spin x_{C,1}, the SA unit 3 flips spin x_{C,3} and spin x_{C,1}. As a result, spin x_{C,1}=0 and spin x_{C,3}=1. In other words, the values of the three spins belonging to the set 21 are “0”, “1”, and “1”, and the condition that the second constraint is satisfied is maintained.

In the concrete example 2, the case where the spin is flipped while the condition that the third constraint is satisfied is maintained is described. Suppose that the states of spins are the states shown in FIG. 5, and that the SA unit 3 selects spin x_{C,4}. In this case, the SA unit 3 selects one set to which the spin x_{C,4} belongs (a set consisting of only basic spins). In this example, it is assumed that the SA unit 3 selects the set 22 (see FIG. 5). The set 22 satisfies the third constraint. If only spin x_{C,4} is flipped, the values of all three spins belonging to the set 22 become “0” and the third constraint is no longer satisfied. Therefore, the SA unit 3 selects other spins to be flipped together with spin x_{C,4} from among the set 22. In this example, either one of spin x_{C,3} or spin x_{C,5} can be arbitrarily selected. Here, the case where spin x_{C,5} is selected will be described as an example.

The SA unit 3 determines whether or not to flip spin x_{C,4} and spin x_{C,5} based on the transition probabilities in the simulated annealing. If it is determined to flip spin x_{C,4} and spin x_{C,5}, the SA unit 3 flips spin x_{C,4} and spin x_{C,5}. As a result, spin x_{C,4}=0 and spin x_{C,5}=1. In other words, the values of the three spins belonging to the set 22 are “0”, “0”, and “1”, and the condition that the third constraint is satisfied is maintained.

In the concrete example 2, the case of flipping a spin so that the fourth constraint is satisfied is described. The states of spins are assumed to be the states shown in FIG. 5.

The set of the basic spin x_{A,1}, the basic spin x_{A,2}, and the auxiliary spin y_{A,(1, 2)} is defined. Similarly, the set of the basic spin x_{A,2}, the basic spin x_{A,3}, and the auxiliary spin y_{A,(2, 3)} is defined. In these sets, the fourth constraint is defined. Thus, when the basic spin x_{A,2} is flipped, the auxiliary spins that may flip with it are the auxiliary spin y_{A,(1, 2)} and the auxiliary spin y_{A,(2, 3)}.

Suppose that the SA unit 3 selects the basic spin x_{A,2}. Then, suppose that the SA unit 3 determines to flip the basic spin x_{A,2}, and flips the basic spin x_{A,2}. In this case, x_{A,2}=1.

Then, since x_{A,1}=1 and x_{A,2}=1, the value of the auxiliary spin y_{A,(1, 2)} is 1×1=1. Therefore, the SA unit 3 flips the auxiliary spin y_{A,(1, 2)} from “0” to “1”.

Also, since x_{A,2}=1 and x_{A,3}=0, the value of the auxiliary spin y_{A,(2, 3)} is 1×0=0. Since y_{A,(2, 3)}=0 already (see FIG. 5), the SA unit 3 does not flip the auxiliary spin y_{A,(2, 3)}.

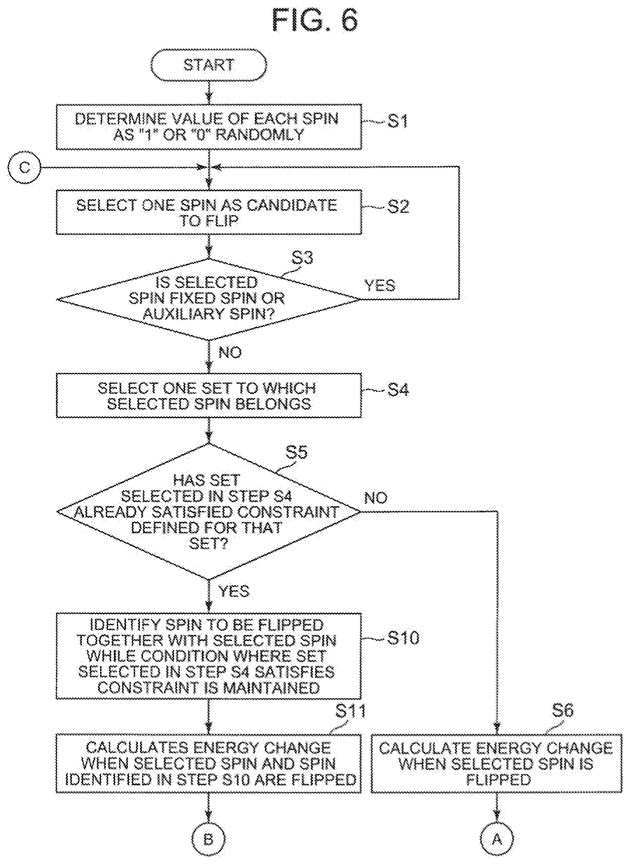

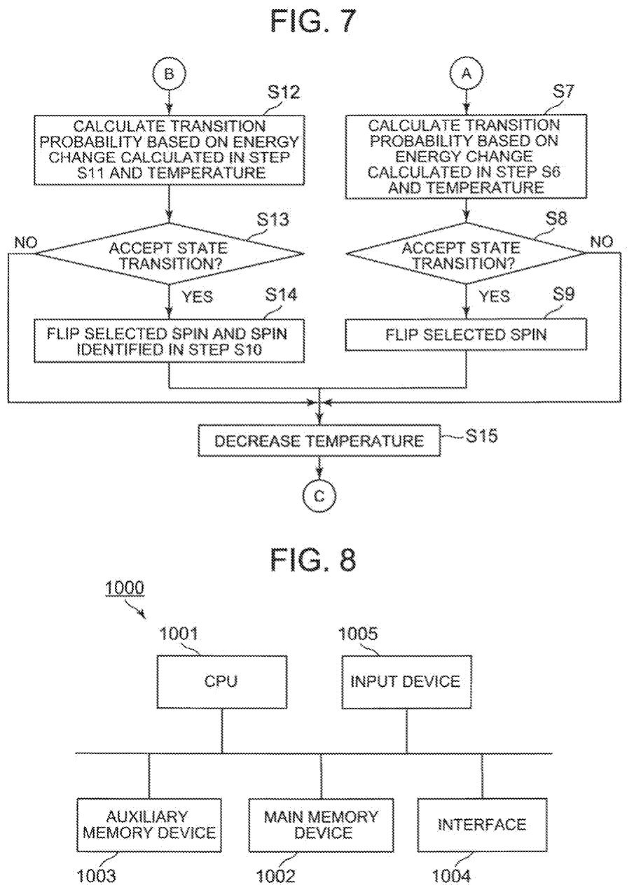

Next, the processing progress will be described. FIG. 6 and FIG. 7 are flowcharts showing an example of a processing progress of the solution system 1 of the example embodiment. It is assumed that each set of spins, and the constraints on each set, are predetermined. If there are spins to which the fifth constraint is defined, it is also assumed that the values (fixed values) of the spins are also predetermined.

It is also assumed that the temperature in simulated annealing is set to the initial value.

When the energy function is input via the input unit 2, the SA unit 3 determines the value of each spin as “1” or “0” randomly under the representation format of the states of spins (e.g., a two-dimensional matrix, etc.) (step S1).

However, the SA unit 3 defines a predetermined fixed value for the fixed spin.

If there are auxiliary spins, the SA unit 3 also determines the value of each auxiliary spin as “1” or “0” randomly.

When step S1 is completed, the constraints defined for each set of spins are not necessarily satisfied.

Next, the SA unit 3 selects one spin as a candidate to flip (step S2). The spin selected in step S2 is hereinafter referred to as the selected spin.

Next, the SA unit 3 determines whether the selected spin is a fixed spin or an auxiliary spin (step S3). If the selected spin is a fixed spin or an auxiliary spin (Yes in step S3), the SA unit 3 repeats the operation from step S2 onward.

If the selected spin is neither a fixed spin nor an auxiliary spin (No in step S3), then the SA unit 3 selects one set to which the selected spin belongs (step S4). Even if there are a plurality of sets to which the selected spin belongs, the SA unit 3 selects one set to which the selected spin belongs.

However, in step S4, the SA unit 3 does not select a set to which the auxiliary spin belongs together with the selected spin. In other words, the SA unit 3 selects a set to which the selected spin belongs but to which the auxiliary spin does not belong.

Next, the SA unit 3 determines whether or not the set selected in step S4 has already satisfied the constraint defined for that set (step S5).

If the set selected in step S4 does not satisfy the constraint defined for that set (No in step S5), then the SA unit 3 calculates the energy change when the selected spin is flipped (Step S6).

Next, the SA unit 3 calculates the transition probability based on the energy change calculated in step S6 and the temperature in simulated annealing (step S7, see FIG. 7).

Next, the SA unit 3 determines whether or not to accept the state transition based on the transition probability calculated in step S7 (step S8).

If the state transition is accepted (Yes in step S8), the SA unit 3 flips the selected spin (Step S9).

Next, the SA unit 3 decreases the temperature in the simulated annealing (step S15). After step S15, the SA unit 3 repeats the operation from step S2 onward.

In addition, if the state transition is not accepted in step S8 (No in step S8), the SA unit 3 moves to step S15 without performing step S9.

As described above, at the time when step S1 is completed, the constraints defined for each set of spins are not necessarily satisfied. However, as the SA unit 3 repeatedly executes the process of steps S6 to S9 and the number of times the selected spin is flipped increases, the number of sets that satisfy the constraints increases.

If the set selected in step S4 satisfies the constraint defined for that set (Yes in step S5), the SA unit 3 identifies a spin to be flipped together with the selected spin while the condition where the set selected in step S4 satisfies the constraint is maintained (step S10). If the condition where the set satisfies the constraint can be maintained even if only the selected spin is flipped, then in step S10, the SA unit 3 need not identify any spin other than the selected spin. In other words, it is possible that no spin other than the selected spin is identified in step S10.

If the fourth constraint is defined, in step S10, the SA unit 3 also identifies the auxiliary spins whose values are to be changed, in accordance with the flip of the selected spin and the flip of the spin that are to be flipped together with the selected spin.

It is also possible that there are basic spins and auxiliary spins, and that none of the first constraint, the second constraint, and the third constraint is defined for the set consisting of the basic spins, and that the fourth constraint is defined for the set containing the basic spins and an auxiliary spin. In such a case, if it is determined that the selected spin is neither a fixed spin nor an auxiliary spin (No in step S3), then the SA unit 3 may immediately move to step S10. Then, in step S10, the SA unit 3 may identify auxiliary spins whose values are to be changed according to flip result of the flip of the basic spin.

Next to step S10, the SA unit 3 calculates the energy change when the selected spin and the spin identified in step S10 are flipped (step S11). As described above, it is possible that no spin other than the selected spin is identified in step S10. In that case, the SA unit 3 may calculate the energy change when the selected spin is flipped, in step S11.

Next, the SA unit 3 calculates the transition probability based on the energy change calculated in step S11 and the temperature in simulated annealing (Step S12, see FIG. 7).

Next, the SA unit 3 determines whether or not to accept the state transition based on the transition probability calculated in step S12 (step S13).

If the state transition is accepted (Yes in step S13), the SA unit 3 flips the selected spin and the spin identified in step S10 (step S14).

Next, the SA unit 3 decreases the temperature in the simulated annealing (step S15). After step S15, the SA unit 3 repeats the operation from step S2 onward.

In addition, if the state transition is not accepted in step S13 (No in step S13), the SA unit 3 moves to step S15 without performing step S14.

As described above, the SA unit 3 repeats the process of steps S2 to S15. Then, for example, in the iterative process, the SA unit 3 moves to step S13 each time, and if the determination result of not accepting the state transition in step S13 is continues for a predetermined number of times in succession, the SA unit 3 may determine that the state of each spin at that time is a state corresponding to a solution of the combinatorial optimization problem. In other words, it may be determined that the state of each spin when the energy is minimized has been obtained. In that case, the output unit 4 outputs the state of each spin. For example, a user of the solution system 1 may refer to the state of each spin and interpret the solution of the combinatorial optimization problem.

According to this example embodiment, if the SA unit 3 determines that a set to which the selected spin belongs satisfies a constraint defined for the set and that the spin is to be flipped, the SA unit 3 flips one or more spins including the selected spin while the condition where the set satisfies the constraint is maintained. Here, changing the condition of a set from a condition where the set satisfies the constraint to a condition where the set does not satisfy the constraint means searching for search candidates that do not satisfy the constraints in the combinatorial optimization problem, in the first place. In the present example embodiment, since the SA unit 3 flips one or more spins including the selected spin while the condition where the set satisfies the constraint is maintained, such a useless search of search candidates can be suppressed. Accordingly, the amount of computation when solving the combinatorial optimization problem can be reduced by applying the energy function in the model representing the states of individual spins with the first value or the second value to the simulated annealing.

As already explained, instead of the energy function in QUBO, the energy function in the Ising model may be input to the solution system 1. In this case, the operation of the SA unit 3 is the same as that described in the example embodiment except that the second value representing the spin state changes from “0” to “−1”.

FIG. 8 is a schematic block diagram showing an example of a computer configuration of the solution system of the example embodiment of the present invention. The computer 1000 includes a CPU 1001, a main memory device 1002, an auxiliary memory device 1003, an interface 1004, and an input device 1005.

The solution system 1 of the example embodiment of the present invention is realized by a computer 1000. The operation of the solution system 1 is stored in the auxiliary storage device 1003 in the form of a solution program. The CPU 1001 reads the solution program from the auxiliary storage device 1003, expands it to the main memory device 1002, and executes the process described in the above example embodiment according to the solution program.

The auxiliary storage device 1003 is an example of a non-transitory tangible medium. Another example of a non-transitory tangible medium is a magnetic disk, an optical magnetic disk, CD-ROM (Compact Disk Read Only Memory), DVD-ROM (Digital Versatile Disk Read Only Memory), semiconductor memory, and the like. Also, when the program is delivered to the computer 1000 via a communication line, the computer 1000 may expand the program to the main memory device 1002 and execute the process described in the above example embodiment according to the program.

Some or all of each of the components may be realized by general purpose or dedicated circuitry, processors, or combinations thereof. These may comprise a single chip or a plurality of chips connected via a bus. Some or all of each of the components may be realized by a combination of the above-described circuits, etc. and a program.

When some or all of each of components is realized by a plurality of information processing apparatuses, circuits, or the like, the plurality of information processing apparatuses, circuits, or the like may be centrally located or distributed. For example, the information processing apparatuses, circuits, or the like may be implemented as a client-and-server system, a cloud computing system, and the like, each of which is connected via a communication network.

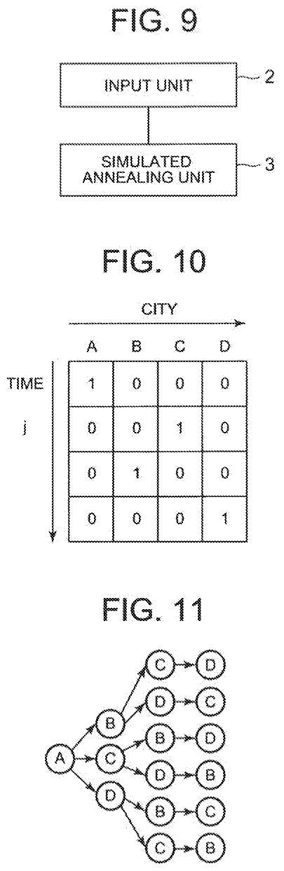

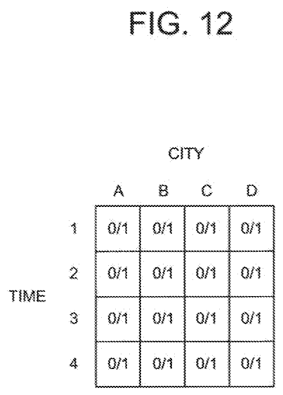

Next, an overview of the present invention will be described. FIG. 9 is a block diagram showing an overview of the solution system of the present invention. The solution system of the present invention includes an input unit 2 and a simulated annealing unit 3.

The input unit 2 receives input of an energy function in a model representing states of individual spins by a first value or a second value (e.g., QUBO, the Ising model), wherein the energy function is corresponding to a combinatorial optimization problem to be solved.

The simulated annealing unit 3 obtains a state of each spin corresponding to a solution of the combinatorial optimization problem by performing simulated annealing when the energy function is input.

In a process of the simulated annealing, the simulated annealing unit selects a spin, selects a set to which the spin belongs, and changes the states of one or more spins including the spin while a condition where the set satisfies a constraint is maintained, when the set satisfies the predetermined constraint and the state of the spin is determined to be changed.

According to such a configuration, the amount of computation when solving a combinatorial optimization problem by applying an energy function in a model representing a state of individual spins by a first value or a second value to simulated annealing can be reduced.

As the constraint to be satisfied by the set, a constraint that only one spin among a plurality of spins belonging to the set takes the first value may be defined.

As the constraint to be satisfied by the set, a constraint that at least one spin among a plurality of spins belonging to the set takes the second value may be defined.

As the constraint to be satisfied by the set, a constraint that at least one spin among a plurality of spins belonging to the set takes the first value may be defined.

If the energy function is input, wherein the energy function is obtained by converting an expression representing energy whose order of variables representing the states of spins is reduced to second order, wherein the expression is obtained, in case order of the variables representing the states of spins of an expression representing the energy in the combinatorial optimization problem is third order or higher, by replacing a plurality of the variables representing the states of spins with a single variable to reduce the order to second order, for the set containing an auxiliary spin corresponding to the single variable after replacement and a plurality of spins corresponding to the plurality of the variables before the replacement, a constraint that the state of the auxiliary spin is changed according to the change of the any spin in the plurality of spins may be defined.

For a predetermined spin, the first value of the second value is defined as a fixed value.

Although the present invention has been described above with reference to example embodiment, the present invention is not limited to the above example embodiment. Various changes may be made to the structure and details of the present invention, that may be understood by those skilled in the art within the scope of the present invention.

### INDUSTRIAL APPLICABILITY

The present invention is suitably applicable to the solution of combinatorial optimization problems.

### REFERENCE SIGNS LIST

1 Solution system
2 Input unit
3 Simulated annealing unit (SA unit)
4 Output unit

What is claimed is:

1. A solution system comprising:
an input unit that receives input of an energy function in a model representing states of individual spins by a first value or a second value, wherein the energy function is corresponding to a combinatorial optimization problem to be solved; and
a simulated annealing unit that obtains a state of each spin corresponding to a solution of the combinatorial optimization problem by performing simulated annealing when the energy function is input,
wherein, in a process of the simulated annealing, the simulated annealing unit
selects a spin, selects a set to which the selected spin belongs, and
changes the states of one or more spins including the selected spin while a condition where the set satisfies a constraint is maintained, when the set satisfies the predetermined constraint and the state of the spin is determined to be changed.

2. The solution system according to claim 1,
as the constraint to be satisfied by the set,
a constraint that only one spin among a plurality of spins belonging to the set takes the first value is defined.

3. The solution system according to claim 1,
as the constraint to be satisfied by the set,
a constraint that at least one spin among a plurality of spins belonging to the set takes the second value is defined.

4. The solution system according to claim 1,
as the constraint to be satisfied by the set,
a constraint that at least one spin among a plurality of spins belonging to the set takes the first value is defined.

5. The solution system according to claim 1,
if the energy function is input, wherein the energy function is obtained by converting an expression representing energy whose order of variables representing the states of spins is reduced to second order, wherein the expression is obtained, in case order of the variables representing the states of spins of an expression representing the energy in the combinatorial optimization problem is third order or higher, by replacing a plurality of the variables representing the states of spins with a single variable to reduce the order to second order,
for the set containing an auxiliary spin corresponding to the single variable after replacement and a plurality of spins corresponding to the plurality of the variables before the replacement, a constraint that the state of the auxiliary spin is changed according to the change of the any spin in the plurality of spins is defined.

6. The solution system according to claim 1,
for a predetermined spin, the first value of the second value is defined as a fixed value.

7. A solution method comprising:
receiving input of an energy function in a model representing states of individual spins by a first value or a second value, wherein the energy function is corresponding to a combinatorial optimization problem to be solved; and
obtaining a state of each spin corresponding to a solution of the combinatorial optimization problem by performing simulated annealing when the energy function is input,
a process of the simulated annealing comprising:
selecting a spin,
selecting a set to which the selected spin belongs, and
changing the states of one or more spins including the selected spin while a condition where the set satisfies a constraint is maintained, when the set satisfies the predetermined constraint and the state of the spin is determined to be changed.

8. A non-transitory computer-readable recording medium in which a solution program is recorded, the solution program to be installed in a computer that comprises an input unit that receives input of an energy function in a model representing states of individual spins by a first value or a second value, wherein the energy function is corresponding to a combinatorial optimization problem to be solved, the solution program causing the computer to perform:
a simulated annealing processing of obtaining a state of each spin corresponding to a solution of the combinatorial optimization problem by performing simulated annealing when the energy function is input,
wherein the solution program causes the computer to perform, in a process of the simulated annealing,
selecting a spin,
selecting a set to which the selected spin belongs, and
changing the states of one or more spins including the selected spin while a condition where the set satisfies a constraint is maintained, when the set satisfies the predetermined constraint and the state of the spin is determined to be changed.
